(19) United States
(12) Patent Application Publication
(10) Pub. No.: US 2021/0007308 A1
(43) Pub. Date: Jan. 14, 2021

(54) ENERGY-EFFICIENT CLOSED PLANT SYSTEM AND METHOD

(71) Applicant: KING ABDULLAH UNIVERSITY OF SCIENCE AND TECHNOLOGY, Thuwal (SA)

(72) Inventors: Jr-Hau HE, Thuwal (SA); Kuan-Sheng HO, Thuwal (SA)

(21) Appl. No.: 16/978,079

(22) PCT Filed: Oct. 18, 2018
(86) PCT No.: PCT/IB2018/058093

§ 371 Date: Sep. 3, 2020

Related U.S. Application Data
(60) Provisional application No. 62/643,379, filed on Mar. 15, 2018.

(51) Int. Cl. A01G 31/06; A01G 7/04; A01C 21/00

(52) U.S. Cl. CPC A01G 31/06; A01C 21/00; A01G 7/045

(57) ABSTRACT

An atmospheric-closed plant-growing system including an annulus that is closed from an ambient of the system; a receptacle located inside the annulus and configured to host a plant; a distribution system located inside the annulus and configured to provide food to the plant; and a temperature distribution system extending into the annulus and configured to provide air at a preset temperature inside the annulus.

### CROSS-REFERENCE TO RELATED APPLICATIONS

This application claims priority to U.S. Provisional Patent Application No. 62/643,379, filed on Mar. 15, 2018, entitled “ENERGY-EFFICIENT INDOOR PLANTING SYSTEM,” the disclosure of which is incorporated herein by reference in its entirety.

### BACKGROUND

### Technical Field

Embodiments of the subject matter disclosed herein generally relate to an enclosed system for growing plants, and more specifically, to a high efficiency closed system for plant growing.

### Discussion of the Background

Today, as the world population is increasing, there is a need to grow plants faster and cheaper. There are various approaches that are trying to achieve this goal. One of them, the hydroponics, is a method of growing plants without soil, by using mineral nutrient solutions in a water solvent. Plants are grown with their roots exposed to the mineral solution as illustrated in FIG. 1.

FIG. 1 shows such a system 100 including a tank 102 that holds water 104. The tank is covered with a lid 106 in which holes are made so that plants 108 can grow. It is noted that the plants 108 are hold in place by a holder 110 and their roots 112 are extending past the holder into the water tank for getting the necessary nutrients. The necessary food is supplied through a supply pipe 114, which also provides the necessary minerals. Light is naturally provided by the sun or, if the system 100 is located inside a green house 120, then, light may be provided from an artificial light source 122, e.g., a LED source.

Thus, in such a hydroponics system the plants grow much faster than those from field farming. In addition, there is no soil, which helps to reduce the cost and to prevent various diseases to spread to the plants and/or between the plants. Artificial or natural light is needed for such a setting. In addition, depending on the geographical location of the farm, regulating the air temperature may be need, for example, cooling if the farm is located in a high-temperature zone or heating, if the farm is located in a low-temperature zone or during a cold season. Thus, an air conditioning system 130 needs to be added to this system.

Some commercial farms using this system claim that hydroponics uses 90% less water than field farming as the plants grow healthily without any pesticide or pollution. This system also advantageously fits more plants into a smaller space and harvesting the crop becomes easier.

Another approach for growing more efficiently the crops is the aeroponics. An aeroponics system is distinct from other soilless plant agricultural methods because, unlike the hydroponics system, which uses a liquid nutrient solution as a growing medium and for providing the essential minerals to sustain plant growth, aeroponics sprays the liquid containing the nutrient solution directly on the plant roots.

The main features of an aeroponics system are that the plants grow fast because their roots have access to sufficient oxygen day and night, the disease transmission is limited since plant-to-plant contact is reduced, the water consumption is believed to be 95% less water than field farming, and the plants grow healthily without any pesticide or pollution. The aeroponics systems may be located outdoor or indoor, similar to the hydroponics system.

However, most of the commercial hydroponics and aeroponics systems suffer from two issues: (1) high energy cost due to low energy utilization efficiency in terms of illumination energy and/or heating/cooling energy, and (2) the limitation to light sources that are not harmful to humans. Utilizing advanced lighting sources (e.g., laser devices) is dangerous for humans due to the risk of eye damage.

Most systems discussed above (whether they are located inside a greenhouse or in open air) fail to overcome the high energy consumption. Although there is no statics of comparison of annual energy usage between aeroponics vs. conventional methods, it is possible to get approximate data through the comparison between hydroponic systems and conventional methods (because the amount of energy consumption in hydroponic and aeroponic systems are similar).

In this regard, the table shown in FIG. 2 shows modeled annual energy use in kilojoules per kilogram of lettuce grown in southwestern Arizona using hydroponic vs. conventional methods. It can be seen that compared to the conventional method, the hydroponic approach requires energy about 90 times higher. Dominating the hydroponic energy usages are the heating and cooling load (for the indoor approach), followed by the energy used for the supplementing the artificial lighting. Because the data illustrated in FIG. 2 is based on an assumption that the light used by the plants is 50% natural light and 50% artificial light, a system having 100% utilization of artificial light will likely use 15% more energy.

For temperature control, most of the existing commercial systems use a system that controls the temperature and humidity in the whole room where the aquaponics system is located. In this situation, a large portion of the energy would be used for cooling or heating non-targets in such a room, for example, walls, unrelated shelves, etc.

For the lighting of the existing systems, the energy dissipation and the low energy conversion efficiency are the two main issues that make the system to use a large amount of energy. In this regard, energy dissipation is present because some light is dissipated to the surrounding, meaning that there are some (most) light lost when energy is transferred from the light source to the leaves of the plants. A second reason for the low energy conversion efficiency for the illumination system is the fact that the electrical to radiative conversion rates of a LED is 10-20%, as the LED systems are one of the most popular energy-saving commercial light source.

As a result, there is a need for a novel system with high efficiency use of energy for illumination and/or temperature control, and also for a system that is safe to the operator of the system.

### SUMMARY

According to an embodiment, there is an atmospheric-closed plant-growing system that includes an annulus that is closed from an ambient of the system; a receptacle located inside the annulus and configured to host a plant; a distribution system located inside the annulus and configured to provide food to the plant; and a temperature distribution system extending into the annulus and configured to provide air at a preset temperature inside the annulus.

According to another embodiment, there is a method for growing plants in an atmospheric-closed plant-growing system. The method includes placing a plant into an annulus of the system, closing the annulus so that the annulus is isolated from an ambient of the system, regulating a temperature inside the annulus, and providing food to the plant inside the annulus.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic illustration of a hydroponics system;

FIG. 2 is a table that compares energy usage of conventional farming and hydroponics based farming;

FIG. 3 shows an aeroponics system that is energy efficient;

FIG. 4 shows a top view of the aeroponics system of FIG. 3;

FIG. 5 shows a cross-view of an aeroponics system that has an annulus sealed from the ambient;

FIG. 6 illustrates a support system for plants to be placed in the aeroponics system;

FIG. 7 shows a receptacle that is configured to hold a plant inside the annulus;

FIG. 8 shows an overview of an aeroponics system having an annulus closed by a door from the ambient;

FIG. 9 is a flowchart of a method for growing plants in a closed aeroponics system; and

FIG. 10 is a schematic diagram of a controller that controls the aeroponics system.

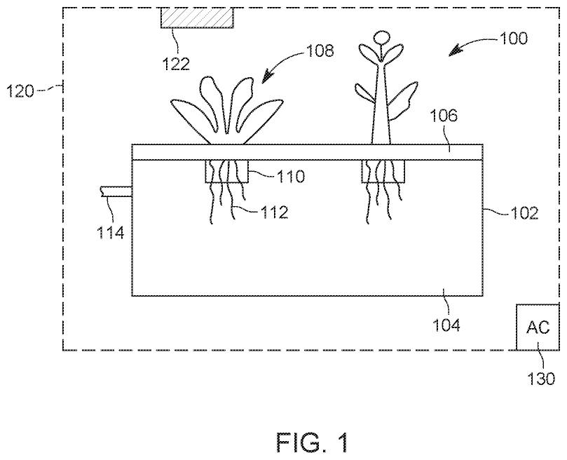

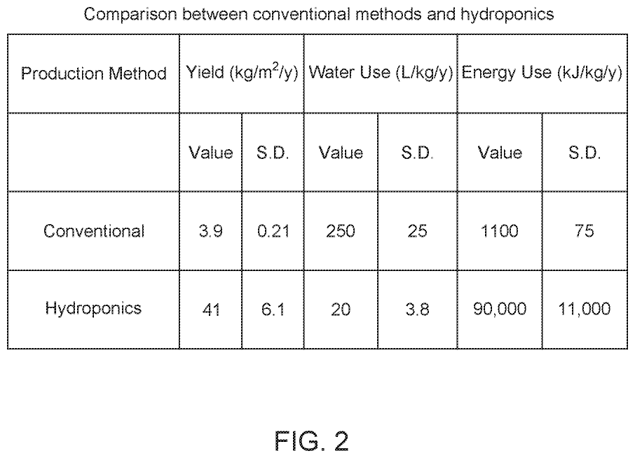

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. For simplicity, the following embodiments are discussed with regard to an aeroponics closed system. However, the embodiments are not limited to this specific case and one skilled in the art would understand that the same features may be used for a hydroponics system or even a traditional system in which soil is used.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, an atmospheric-closed plant-growing system has a housing that fully encloses one or more plants. The housing is formed as the annulus between an internal wall and an external wall. Note that although the accepted definition of the term annulus is a space defined by two circular walls, in this application, this term is used as being a space defined by two walls, one internal and one external, where the external wall fully encloses the internal wall and the shape of a transversal cross-section of the internal and external walls can be circular, square, rectangular, triangular, etc. The internal wall is so configured to accommodate a source of light, but the source of light is not located in the annulus. A temperature regulating device controls the temperature and/or humidity inside the housing. The housing has top and bottom panels that seal the annulus so that no air enters inside the housing from the ambient. Thus, the temperature regulating device consumes less energy as it has to maintain constant the temperature and/or humidity only of the housing, and not of the air around the housing. The housing is scaled depending on the type of the plants so that a volume of air inside the housing, which is not occupied by the plants, has a minimum possible value. A nutrient system is distributed inside the housing to provide the necessary nutrients to each plant. In one application, the housing has a door that can be opened so that direct access to the plants is possible. The outside wall of the housing can be treated so that no or almost no light escapes from the housing.

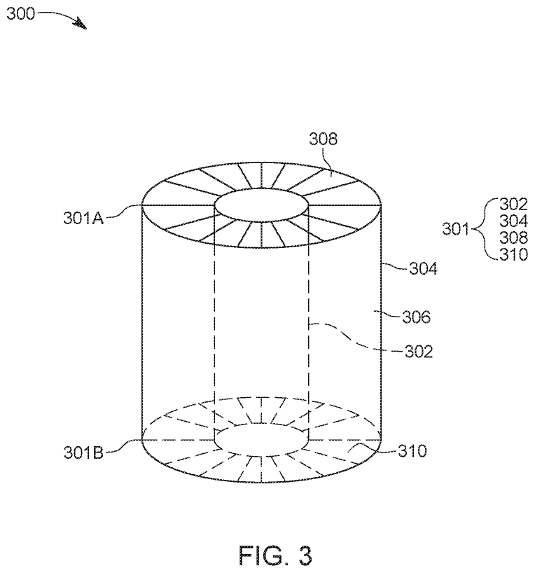

The atmospheric-closed plant-growing system is now discussed with regard to FIG. 3. The system 300 has a housing 301 that includes an internal wall 302 and an external wall 304 that define an annulus 306. Although FIG. 3 shows the internal and external walls being cylindrical, it is possible to use other shapes, e.g, conical, cuboid, parallelepiped, quadrilateral frustrum, rectangular cuboid, etc. The top part 301A of the housing 301 is closed by a top side 308 and the bottom part 301B of the housing is closed by a bottom side 310. In this way, the annulus 306 is completely closed from the atmosphere. The internal wall, external wall, top side and bottom side may be made from a transparent plastic, a polymer, glass or other similar materials. In one application, all these elements are made of the same material. In another application, the internal wall is transparent to light while the other components of the housing may be made of materials that are not transparent to light, for example, plastic, wood, metal, etc.

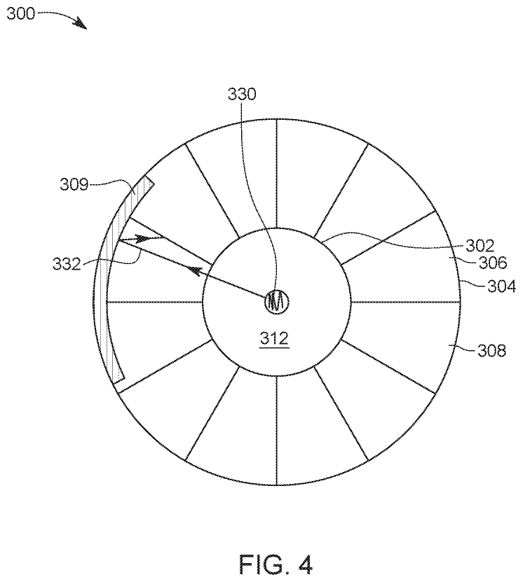

FIG. 4 shows a top view of the housing 301. This figure shows that an internal passage (or volume) 312 defined by the internal wall 302 and the internal passage is open to the atmosphere so that air or any other fluid may freely enter inside. In one embodiment, a light source 330 is placed in the internal passage 312. The internal light source may be any known light source, for example, a T5 lamp, LED bulbs, LED array, or any other omnidirectional light source. However, for energy efficiency reasons, the light source 330 may be selected to be a laser or a laser array. Plants cultivated inside the annulus 306 face directly the light source 330. Because of the enclosed design of the internal and external walls, the light source can provide photosynthesis in a 360° region, making the irradiation evenly utilized by ambient plants. In one application, the external wall 308 may be internally coated with a highly reflective layer 309, as shown in FIG. 4, so that a high percentage of the emitted light 332, which is not absorbed by the leaves of the plants, bounces back inside the annulus 306. In this way, most if not all the light generated by the source light 330 is used by the plants and a minimal amount of light is lost to the environment. Further, even if the source light 330 uses a laser beam that might be damaging to the eye of a human, it is unlikely that this light escapes outside the annulus due to the highly reflective layer 309. Thus, more energy efficient light sources may be used in the system 300 as this light is unlikely to escape outside the outer wall 304, and light dissipation is reduced comparative to the existing systems.

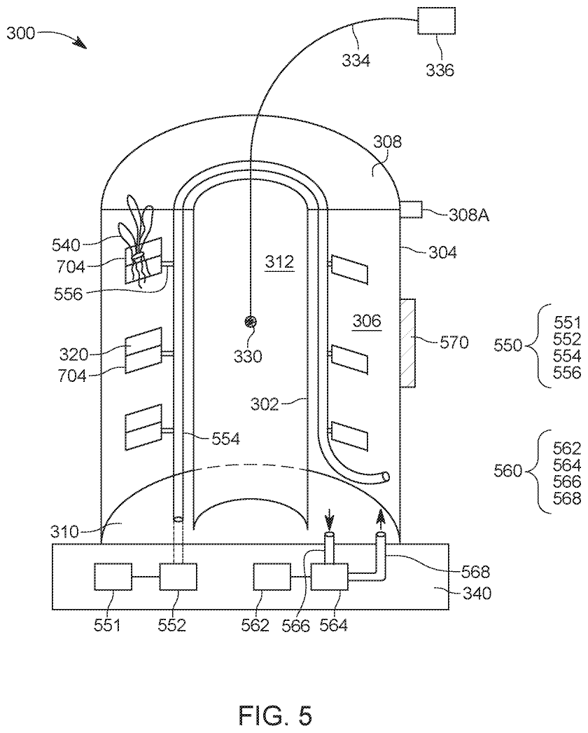

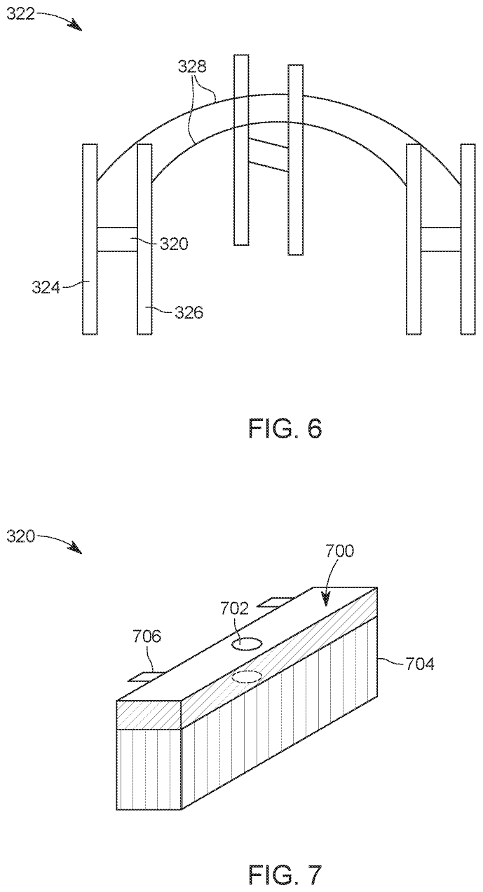

A half-section of the system 300 is shown in FIG. 5. This half-section shows the light source 330 hanging deep inside the internal passage 312. A cable 334 is providing electrical power to the light source from a power source 336. In one application, the system 300 is placed on a pedestal 340, which can accommodate the power source 336. Further, FIG. 5 shows plural receptacles 320 provided in the annulus 306. The receptacles 320 may be attached to the external wall 304, or to the internal wall 302, to both of these walls, of they may have their own support structure 322 as illustrated in FIG. 6. Support structure 322 is designed to fit in the annulus 306 and may have, for example, plural poles 324 and 326 that support the receptacle 320. Plural pairs of these poles are attached to each other by rods 328. Although FIG. 6 shows the pair of poles 324 and 326 being connected to a single receptacle, it is possible to have plural receptacles attached to a single pair of poles.

In one embodiment, receptacle 320 can be implemented as illustrated in FIG. 7. In this embodiment, the receptacle 320 has a top part 700 in which a hole 702 is formed. A basket 704 is connected beneath the top part 700. The hole 702 is designed to accommodate a plant and the basket 704 is designed to accommodate the roots of the plant. If a hydroponics approach is adopted, then the basket is made to hold water and nutrients. However, if an aeroponics approach is adopted, then the basket has many holes and/or slots so that water and/or nutrients may be sprayed onto the roots of the plant. The receptacle 320 may also have a connecting system 706, for example, a hook or a metal part that can be attached to the external wall, or internal wall or to the support system 322 of FIG. 6. Other implementations of the receptacle may be envisioned based on the disclosed embodiments.

Returning to FIG. 5, a nourishing system 550 for the plants 540 is now discussed. The nourishing system 550 may include a food tank 551 that includes water and nutrients that are necessary for the growing of the plant. Various other chemicals may be added to food tank 551 for preventing or curing diseases associated with the plants. The food tank 551 may be placed in the pedestal 340. A pump 552, also located inside the pedestal 340, may send the food along a distribution system 554 (e.g., pipes) inside the annulus 306 to each plant 540. A head 556 breaks from the distribution system 554 and enters the basket 704 of each receptacle 320 for spraying the food to the roots of each plant. The head 556 may be a sprayer if the aeroponics approach is taken. If the hydroponics approach is adopted, then head 556 may include an input pipe and an output pipe so that the food is circulated through the basket 704. For this case, the distribution system 554 is routed back to the tank 551 after all the plants are fed. Note that the distribution system may include plural pipes that feed groups of the plants located in the annulus 306.

FIG. 5 also shows a temperature regulating system 560 that is configured to regulate a temperature inside the annulus 306. In one application, the temperature regulating system 560 may be configured to also regulate the humidity inside the annulus. In one application, the temperature regulating system may be an AC unit. The temperature regulating system 560 may include a power source 562 which provides power to the main AC unit 564. The AC unit 564 cools or heats the intake air, which is received along intake piping 566, which opens up inside the annulus 306, and then returns that controlled temperature volume of air back to the annulus 306, along a temperature distribution system 568. In one embodiment, the temperature distribution system 568 may include one or more ducts and/or pipes. One skilled in the art would understand that the location of pipes 566 and 568 inside the annulus may be changed for optimal cooling or heating.

However, different from the existing devices for growing plants, the system 300 controls the air inside the annulus 306, where the plant resides, by cooling or heating it. Because the volume of the annulus is small, the amount of energy for heating or cooling the annulus is very small, which makes this system very energy efficient. In addition, an exterior of the exterior wall 304 and/or the sides 308 and 310 may be insulated, partially or totally, with a thermally insulating layer 570, to further reduce the heat exchange between the annulus and the ambient, through these elements. This is possible especially because the light is provided from inside the internal passage 312, and not through the external wall 304 or the top side or bottom side of the annulus. In other words, because only a small enclosure (annulus) needs to be cooled or heated, the sealed thermally insulating system 300 saves more energy than contemporary commercial designs that air-condition the entire greenhouse or room in which the hydroponics or aeroponics system are placed. Further, because the system 300 is operated independent of other devices, it can be scaled for any desired crop volume, by simply adding more of these units.

Access to the crop inside the annulus 306 may be achieved in various ways. In one implementation, the top side 308 can be detached from the annulus and direct access to the plants is obtained. For example, as also illustrated in FIG. 5, the top side 308 may be attached with one or more hooks 308A to the external wall 304 or the internal wall 302 or both. Alternatively, the top side 308 may have teeth that mate with corresponding teeth in the external or internal wall. In another implementation, the entire annulus may be detached from the bottom side 310. The bottom side 310 may be part of the pedestal 340. In still another application, at least one of the bottom side, the exterior wall, the interior wall or the top side may have small holes for allowing a reduced amount of air to escape from the annulus and a corresponding amount of air to enter the annulus to balance the chemical composition of the air inside the annulus. The amount of air that escapes the annulus is designed to be small enough so that not a substantial amount of thermal energy is exchanged with the ambient.

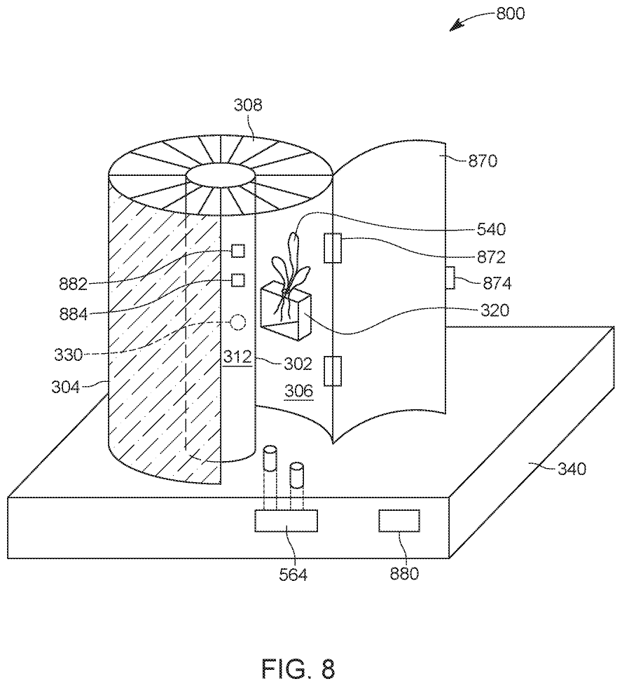

In still another implementation, as illustrated in FIG. 8, the atmospheric-closed plant-growing system 800 has a door 870 that allows access to the plants 540 inside the annulus 306. FIG. 8, shows for simplicity, a single plant 540 accommodated by a single receptacle 320. For a better view of the various components, the nourishing system 550 is omitted in this figure. Door 870, which may be made of the same material as the walls of the system, may be attached to the external wall 304 with one or more hinges 872. A locking mechanism 874 may be provided on the door 870 for maintaining the door closed. One skilled in the art would understand that the door 870 may be implemented in other ways, e.g., as a sliding door, automatic door, etc.

FIG. 8 also shows a processor 880 (controller) located in the pedestal 340 and one or more sensors 882 and 884. In one application, the first sensor 882 is a temperature sensor and the second sensor 884 is a humidity sensor. Other sensors may be added to the system, like a light intensity sensor, etc. The sensors, the temperature regulating system 560 and the nourishing system 550 may all be connected to the processor 880. The processor 880 is programmed to maintain a certain temperature inside the annulus, based on readings from the temperature sensor. The processor 880 may also be programmed to maintain a certain humidity inside the annulus, based on readings from the humidity sensor. The processor may also be programmed to feed the plants at certain times for certain durations. In addition, the processor may be programmed to switch on and off the light source 330 based on a preestablished schedule. In one embodiment, then processor may be programmed to switch the nourishing system from hydroponics to aeroponics or the other way around. For this type of embodiment, the system may include both a hydroponics system and an aeroponics system. These changes may be triggered by the various growing stages of the plants present inside the annulus. By using the processor 880, the system 300 may be fully automatized.

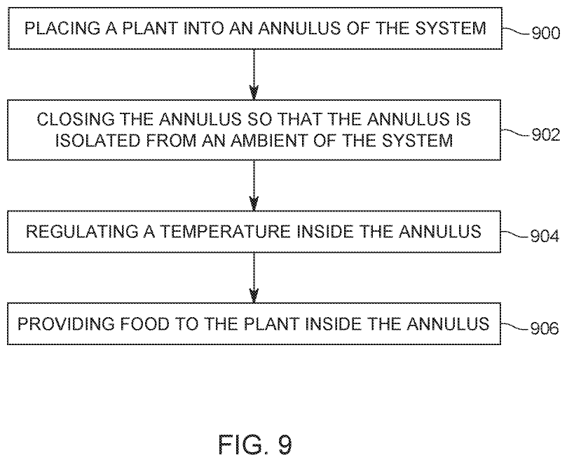

A method to use an atmospheric-closed plant-growing system is now discussed with regard to FIG. 9. FIG. 9 includes a step 900 of placing a plant into an annulus of the system, a step 902 of sealing the annulus from the atmosphere, a step 904 of regulating a temperature inside the annulus, and a step 906 of providing food to the plant, inside the annulus.

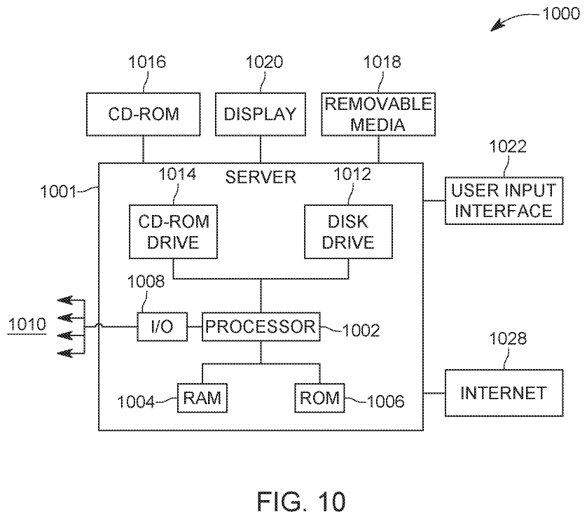

The above-discussed procedures and methods may be implemented in a computing device or controller 1000 as illustrated in FIG. 10. Hardware, firmware, software or a combination thereof may be used to perform the various steps and operations described herein. In one application, the processor 880 in FIG. 8 can be implemented as the computing device 1000.

Computing device 1000 suitable for performing the activities described in the exemplary embodiments may include a server 1001. Such a server 1001 may include a central processor (CPU) 1002 coupled to a random access memory (RAM) 1004 and to a read-only memory (ROM) 1006. ROM 1006 may also be other types of storage media to store programs, such as programmable ROM (PROM), erasable PROM (EPROM), etc. Processor 1002 may communicate with other internal and external components through input/output (I/O) circuitry 1008 and bussing 1010 to provide control signals and the like. Processor 1002 carries out a variety of functions as are known in the art, as dictated by software and/or firmware instructions.

Server 1001 may also include one or more data storage devices, including hard drives 1012, CD-ROM drives 1014 and other hardware capable of reading and/or storing information, such as DVD, etc. In one embodiment, software for carrying out the above-discussed steps may be stored and distributed on a CD-ROM or DVD 1016, a USB storage device 1018 or other form of media capable of portably storing information. These storage media may be inserted into, and read by, devices such as CD-ROM drive 1014, disk drive 1012, etc. Server 1001 may be coupled to a display 1020, which may be any type of known display or presentation screen, such as LCD, plasma display, cathode ray tube (CRT), etc. A user input interface 1022 is provided, including one or more user interface mechanisms such as a mouse, keyboard, microphone, touchpad, touch screen, voice-recognition system, etc.

Server 1001 may be coupled to other devices, such as a smart device, e.g., a phone, tv set, computer, etc. The server may be part of a larger network configuration as in a global area network (GAN) such as the Internet 1028, which allows ultimate connection to various landline and/or mobile computing devices.

The disclosed embodiments provide methods and systems for growing plants in a sealed or almost sealed environment so that an amount of thermal energy exchanged with the environment is minimized. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. An atmospheric-closed plant-growing system comprising:
an annulus that is closed from an ambient of the system;
a receptacle located inside the annulus and configured to host a plant;
a distribution system located inside the annulus and configured to provide food to the plant; and
a temperature distribution system extending into the annulus and configured to provide air at a preset temperature inside the annulus.

2. The system of claim 1, further comprising:
an internal wall that forms an internal passage located outside the annulus; and
an external wall that fully encircles the internal wall,
wherein the internal wall and the external wall define the annulus.

3. The system of claim 2, wherein a cross-section of each of the internal wall and the external wall is circular.

4. The system of claim 2, further comprising:
a top side connected to the internal wall and to the external wall; and
a bottom side connected to the internal wall and to the external wall,
wherein the internal wall, the external wall, the top side and the bottom side completely define the annulus and seals it from the ambient.

5. The system of claim 2, wherein the receptacle is attached to the external wall.

6. The system of claim 2, wherein the receptacle is attached to the internal wall.

7. The system of claim 2, further comprising:
a light source located inside the internal passage, wherein the light source generates light for the plant.

8. The system of claim 7, wherein the light source is a laser device.

9. The system of claim 7, further comprising:
a nourishing system which supplies the food to the distribution system, and the nourishing system is located outside the annulus.

10. The system of claim 9, further comprising:
a temperature regulating system which supplies heated or cooled air to the temperature distribution system, and the temperature regulating system is located outside the annulus.

11. The system of claim 10, further comprising:
a processor that is connected to and controls the nourishing system and the temperature regulating system.

12. The system of claim 11, further comprising:
a pedestal on which the internal and external walls are placed and the nourishing system, the temperature regulating system and the processor are located inside the pedestal.

13. The system of claim 2, further comprising:
a door attached to the external wall, the door being configured to open to provide access to the plant.

14. A method for growing plants in an atmospheric-closed plant-growing system, the method comprising:
placing a plant into an annulus of the system,
closing the annulus so that the annulus is isolated from an ambient of the system;
regulating a temperature inside the annulus; and
providing food to the plant inside the annulus.

15. The method of claim 14, further comprising:
placing a receptacle inside the annulus to host the plant.

16. The method of claim 15, further comprising:
providing food to the plant with a distribution system located inside the annulus; and
controlling a temperature inside the annulus with a temperature distribution system.

17. The method of claim 14, wherein the annulus is bordered by an internal wall that forms an internal passage and an external wall that fully encircles the internal wall, and the internal passage is outside the annulus.

18. The method of claim 17, wherein a top of the annulus is defined by a top side, which is connected to the internal wall and to the external wall, and a bottom of the annulus is defined by a bottom side, which is connected to the internal wall and to the external wall, wherein the internal wall, the external wall, the top side and the bottom side completely define the annulus and seals it from the ambient.

19. The method of claim 17, further comprising:
placing a light source inside the internal passage, wherein the light source generates light for the plant.

20. The method of claim 19, wherein the light source is a laser device.
